(19) United States
(12) Patent Application Publication
(10) Pub. No.: US 2004/0104659 A1
(43) Pub. Date: Jun. 3, 2004

(54) Semilamp for retrofitting of lamps with inductive ballasts for electronic operation

(76) Inventor: Walter Holzer, Meersburg (DE)

Correspondence Address: MERCHANT & GOULD PC, P.O. BOX 2903, MINNEAPOLIS, MN, 55402-0903, US

(21) Appl. No.: 10/464,808

(22) Filed: Jun. 18, 2003

Related U.S. Application Data
(63) Continuation of application No. 09/890,058, filed on Oct. 2, 2001, now abandoned.
Application No. 09/890,058 is a 371 of international application No. PCT/IB00/00090, filed on Jan. 28, 2000.

(30) Foreign Application Priority Data
Jan. 31, 1999 (DE) 199 03 669.1
Nov. 15, 1999 (DE) 199 55 072.7

(51) Int. Cl. H01J 5/48

(52) U.S. Cl. 313/318.01

(57) ABSTRACT

The invention facilitates insertion of fluorescent semilamps for retrofitting of existing fluorescent lamps with inductive ballasts to electronic high-frequency ballast operation. The pin bases of the semilamps are designed to be separably rotatable as opposed to the previously rigid pin base assembly. The rotatable pin base allows easy insertion of the new semilamps into existing lamps, with only the pin base being rotated to secure the semilamps in their sockets. The semilamp may further provide a grip to aid in the rotation of the pin base, locking snaps to secure the rotatable pin base, or length equalization between different types of fluorescent lamps by addition of an expansion shoulder to the pin base.

### BACKGROUND OF THE INVENTION

Substantial progress has been made in the development of fluorescent lamps in recent years. For example, light output of fluorescent lamps has been increased substantially by reducing the diameter of the glass tubing used to form fluorescent lamps, i.e. to 16 mm, and by the use of new fluorescent materials. When compared with previous fluorescent lamps with 40 or 27 mm diameter tubes, these new reduced-diameter tubes demonstrate an increase in light output of up to 50%. According to some trade literature, these new reduced-diameter tubes operate at up to 104 lumen per watt.

Light quality can also be significantly improved, not only by the use of reduced-diameter tubes and new fluorescent materials, but also by the use of higher frequencies passing through the flourescent tubes. The stroboscope effect, often associated with the use of low frequencies, is avoided with the utilization of higher frequencies.

However, high-performance fluorescent lamps require an electronic ballast and cannot easily be used as replacements in conventional fluorescent lighting assemblies which use inductive ballasts.

As a consequence, hundreds of millions of existing fluorescent lighting assemblies are obsolete and require an urgent remedy. The desire for replacement of the obsolete assemblies with the high-performance fluorescent lamps is universal, however, the high costs associated with the disassembly of the old lamps and the installation of new high-performance fluorescent lamps is often a disincentive.

Attempts to address the problem of high costs have resulted in the creation of semilamps. Semilamps are lamps by which, in principle, solve this problem. Semilamps are flourescent housings into which the new high-power fluorescent lamps can be usually inserted. The semilamps, in turn, are insertable into existing lamps for retrofitting to the high-performance fluorescent lights.

Such semilamps or adaptor sets also contain all the electronic components for high-frequency operation. However, if possible, they must be equipped with a reflector that widens the light-emitting surface of the thin high-power fluorescent lamps. The reflector reduces dazzling and increases the light output of the semilamp. Both the electronic components and the reflector, however, take up a great deal of room.

In order to insert the old fluorescent lamp into a socket, the lamp is initially inserted with its pin bases into the sockets and then rotated approximately 90° about its longitudinal axis to secure it against falling out. The same procedure must be done with the entire semilamp in order to insert it in an existing lamp. With the addition of the electronic components and reflector to the semilamp, this rotational manipulation is not only unpractical, but greatly restricts the latitude for semilamp designers.

### SUMMARY OF THE INVENTION

The task of the present invention is to provide a semilamp that may be inserted into an existing lamp without the entire semilamp having to be pivotally moved. Because the 90° movement required to insert a typical lamp greatly reduces the design allowances of the semilamp, the apparatus of the present invention greatly increases the design possibilities of the semilamp. A preferred embodiment of the present invention allows the pin bases of a semilamp to separably rotate, enabling the semilamp to be inserted into an existing lamp without the entire semilamp having to be pivotally moved.

According to one aspect of the present invention, an semilamp apparatus utilizing pin bases, arranged at the ends of the semilamp, which are separably rotatable 90° about their longitudinal axises. The semilamp and pin bases are inserted into an existing lamp base with the semilamp arranged in its operating alignment and the pin bases rotated 90° to its insertion alignment. Once inserted into the existing lamp, the pin bases are separably rotated, with the semilamp making little or no pivoting movements, securing the semilamp within the lamp base.

According to another aspect of the present invention, a semilamp apparatus with separably rotatable pin bases, the pin bases being further provided with corresponding stops and snaps to facilitate the pivoting movement of the pin bases and offer a stable mount for the semilamp.

According to still another aspect of the present invention, a semilamp apparatus with separably rotatable pin bases, the pin bases being further provided with ribbing or hand grips to facilitate the pivoting movement of the pin bases by the operator.

Furthermore, the so-called T5 fluorescent lamps recently available on the market are characterized by better efficiency, i.e., more lumens per watt, but are somewhat shorter than the comparable T8 or T10 fluorescent lamps. The difference in length between the different model lengths is about 40 to 50 mm. Because of this length difference, any universal semilamp design must be able to fit these different model types.

Therefore, according to yet another aspect of the present invention, a semilamp apparatus with separably rotatable pin bases, the pin bases being further equipped with shoulders of different lengths that carry the pins. The variable length shoulder allows the semilamp assembly to be universally adapted to the differing lengths of specific fluorescent lamp models.

### BRIEF DESCRIPTION OF THE DRAWINGS

The features and advantages of the present invention will become more apparent from the following detailed description of the preferred embodiments of the invention taken in conjunction with the drawings.

FIG. 1 shows a semilamp in accordance with the present invention, the semilamp being separate from a lamp socket.

FIG. 2 shows the same semilamp with the pin base pivoted by 90°.

FIG. 3 shows a semilamp in accordance with the present invention, the semilamp being inserted into an existing lamp socket.

FIGS. 4 and 5 show a rigid semilamp without a rotatable pin base during an attempt to insert the semilamp into an existing lamp socket.

FIG. 6 is a view of a rotatable base in accordance with the present invention, with stops, snap and grip.

FIG. 7 is side view of the same rotatable base of FIG. 6.

FIG. 8 shows the same rotatable base of FIG. 7 with an increased shoulder width.

### DETAILED DESCRIPTION OF PREFERRED EMBODIMENTS

The following description of the present invention is to be construed as illustrative only and is for the purpose of teaching those skilled in the art the best mode of carrying out the invention. The details may be varied substantially without departing from the spirit of the invention, and the exclusive use of all modifications which are within the scope of the appended claims is reserved.

The designations used in the following description for the base/socket system G5 and G13 correspond to the worldwide standardized systems, but are also not to be interpreted as restrictive. The G5 and G13 base/socket system, however, are the most widespread systems in use. In particular, the base/socket system G5 is provided for the new high-power fluorescent lamp with a 16 mm diameter. For this reason, the following description refers to the G5 base/socket system. As those skilled in the art will recognize, the present invention can also be used for any other, even a future, base/socket system.

Referring now to the drawings, wherein like reference numerals designate identical or corresponding parts throughout the several figures, and more particularly to FIG. 1, a semilamp consists essentially of a reflector (1), and a G13 pin base (2) with pins (19) located on both end surfaces of the reflector (1). The G13 pin base (2) and pins (19) are rotatable according to the invention by at least 90° around their longitudinal axis (3). Two G5 sockets (4) are arranged within the reflector (1), into which a high power fluorescent lamp (5) can be inserted. The components of an electronic ballast required for operation of a high power fluorescent lamp are accommodated in a housing (6).

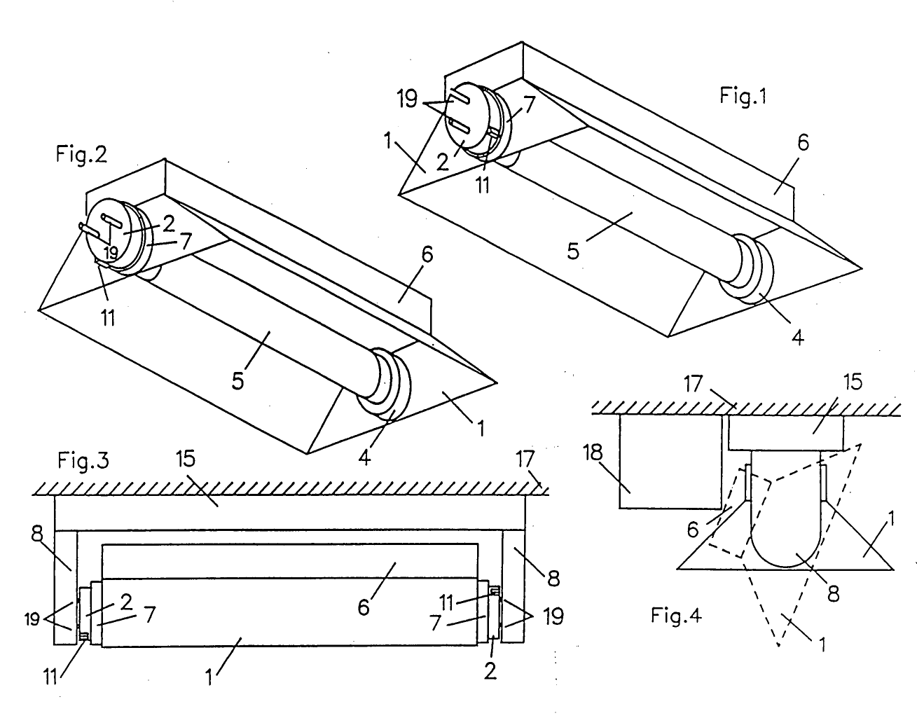

FIG. 2 shows the semilamp of FIG. 1 with the G13 pin base (2) rotated 90°. The G13 pin base (2) rotates in order to secure the semilamp into an existing lamp (15), after insertion, by the transverse position of the pins (19).

FIG. 3 shows a view of the semilamp according to the present invention in its inserted position in the existing lamp (15). The semilamp is inserted, along with the reflector (1), the two rotatable G13 pin bases (2) and the housing (6) into the G13 sockets (8). The G13 pin bases (2) in FIG. 3 are shown in their original, non-rotated position, i.e., the two pins (19) can still be seen in their insertion position. A grip (11) is operable connected to each of the G13 rotatable pin bases (2). The grips (11) are rotated about their longitudinal axies (3), securing the semilamp into the existing lamp (15).

FIG. 4 shows the problem associated with trying to insert a rigid semilamp into the existing lamp (15). In a rigid semilamp apparatus, the entire semilamp along with the reflector (1) and the housing (6), must be pivoted 90° for insertion of the pins (19) of the G13 pin base (2) into the G13 sockets (8). During insertion and rotation of the rigid semilamp, the rigid semilamp components come into contact with the existing lamp (15) preventing the rigid semilamp from completing its rotation. For example, the rigid semilamp may experience resistence from an inductive ballast (18), the base of the existing lamp (15), or other parts that are attached on the cover (17), as depicted by the dashed line.

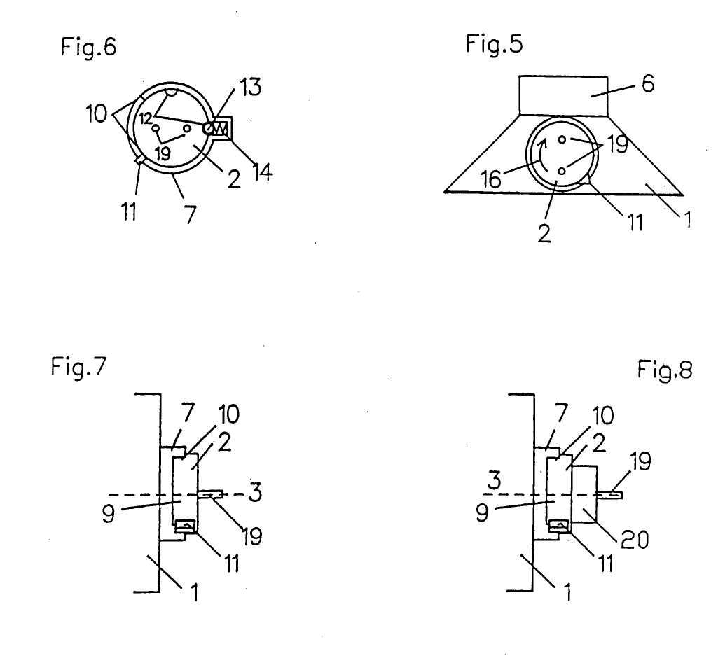

Turning now to FIG. 5, the present invention solves the problems associated with trying to insert a rigid semilamp by utilizing a separably rotatable G13 pin base (2). In the vertical position of pins (19) shown in FIG. 5, the G13 pin base (2) can be pushed into a G13 socket (8) without the semilamp contacting any components of the existing lamp (15). The rotatable pin base (2) is rotated in the direction of the arrow (16), securing the semilamp in the existing lamp (15). Other embodiments of the present invention are depicted in FIGS. 6 and 7. In these embodiments, the rotatable mounting of the G13 pin base (2) can occur, for example, in a sleeve (7) that delimits a defined rotational movement with a recess (9) working in cooperation with the grip (11). During rotation, the grip (11) on the G13 pin base (2) contacts one of the stops (10) of the recess (9) terminating the rotational movement of the G13 pin base (2).

In order to prevent undesired rotational movement, for example by vibrations, a snap is provided to secure the position of the G13 pin base (2). In the illustrated embodiment, a ball (13), snaps into notches (12) under the pressure of a spring (14). Therefore, the G13 pin base (2) may be snapped into any desired position and remain there until sufficient force is used to overcome the snap. This snap embodiment is also to be interpreted as merely illustrative, as any desired snap, for example an elastically deformable plastic assembly, may also be used by someone skilled in the art.

In yet another embodiment of the semilamp according to the present invention, FIG. 8 shows the G13 pin base (2) adapted to use a shoulder (20) to extend the length of the G13 pin base (2) and thereby work with other fluorescent lamp models. In this embodiment, the pins (19) are arranged slightly elevated on the shoulder (20) of the G13 pin base (2). Depending on the length difference of the T5 lamp relative to the previously used T8 or T10 fluorescent lamp, the shoulder (20) can vary in size to efficiently span the length difference. Furthermore, the shoulder (20) can be molded directly onto the G13 pin base (2) from plastic or alternatively it can be designed as a separate intermediate disk.

To summarize, the introduction of expensive high-performance fluorescent lamps has created a demand for the capability of retrofitting existing lamps to the new electronic high-frequency operation, without requiring the installation of the more expensive high-performance fluorescent lamp sockets. By retrofitting, the customer can take advantage of the new, more efficient fluorescent lamps, without incurring a huge expense. The arrangement of rotatable pin bases according to the present invention allows designers of retrofitting lamps to utilize the technology of the newer lamp. Without the present invention, it is apparent that a universally useable and universally insertable retrofitting lamp will find no broad possibility for application.

What is claimed is:

1. Semilamp for retrofitting of lamps with inductive ballast for electronic operation with two sockets to accommodate a fluorescent lamp and an integrated ballast, in which two pin bases are present on the ends for insertion in a lamp, characterized by the fact that the pin bases arranged on the ends of the semilamp are rotatable around the longitudinal axis by about 90° for insertion into an existing lamp.

2. Semilamp according to claim 1, characterized by the fact that stops are present that limit the angle of rotation.

3. Semilamp according to one of the preceding claims, characterized by the fact that snaps are present in the end positions of the rotational movement.

4. Semilamp according to one of the preceding claims, characterized by the fact that grips for simple operation are present on the rotatable pin base.

5. Semilamp according to one of the preceding claims, characterized by the fact that the rotatable pin bases are equipped with shoulders of different height, which carry the pins and permit adjustment of the semilamp to different spacings of the lamp sockets.
